(19) United States
(12) Patent Application Publication
(10) Pub. No.: US 2003/0114068 A1
(43) Pub. Date: Jun. 19, 2003

(54) Article of manufacture useful as wallboard and a method for the making thereof

(75) Inventors: Bobby Mal Phillips, Jonesborough, TN (US); Leron Ronnie Dean, Kingsport, TN (US)

Correspondence Address: KENNEDY COVINGTON LOBDELL & HICKMAN, LLP, 100 NORTH TRYON STREET, BANK OF AMERICA CORPORATE CTR. SUITE 4200, CHARLOTTE, NC, 28202, US

(73) Assignee: Clemson University Research Foundation, Clemson, SC (US)

(21) Appl. No.: 10/319,069

(22) Filed: Dec. 13, 2002

Related U.S. Application Data
(60) Provisional application No. 60/341,493, filed on Dec. 17, 2001.

(51) Int. Cl. D04H 1/00; D04H 3/00; D04H 5/00; D04H 13/00; B32B 5/26

(52) U.S. Cl. 442/381; 442/327

(57) ABSTRACT

An article of manufacture particularly suitable as wallboard, the article comprising a bonded nonwoven structure sandwiched between two layers of paper, wherein the bonded nonwoven structure comprises a binder and a load-bearing fiber wherein the load-bearing fiber has a shape factor between about 2 and 6, a short range distortion factor (SRDF) between about 5 and 70, a long range distortion factor (LRDF) between about 0.1 and 0.6, and a denier per filament (dpf) between about 3 and 200. A method of making the article is also disclosed.

### CROSS-REFERENCE TO RELATED APPLICATIONS

This application claims the benefit of U.S. provisional application serial No. 60/341,493, filed Dec. 17, 2001.

### FIELD OF THE INVENTION

The present invention relates to an article of manufacture that is particularly suitable for wallboard. The present invention also relates to a method of making the article.

### BACKGROUND OF THE INVENTION

Currently, wallboard is made from gypsum covered with special paper, which is also commonly referred to as sheet rock. The advantages offered by sheet rock are low cost, flame retardancy, and ease of installation. However, there is a continuing desire to reduce the weight of these boards. The density of the gypsum boards is typically between 35 lb/ft³ (560 kg/m³) and 40 lb/ft³ (640 kg/m³). As an alternative, companies have attempted for years to arrive at a commercially viable process for reducing the density of polyester materials and to effectively and economically make a polyester foam but have been unsuccessful.

U.S. Pat. No. 3,755,051 discloses a high-loft nonwoven material made from conventional fibers for use as a covering material such as a wall panel and a method of making the same.

U.S. Pat. No. 4,158,938 discloses foamed plastic panels useful for wallboard. However, in particular, it relates to a means for connecting adjacent foam panels.

U.S. Pat. No. 4,216,136 discloses fire retardant resin compositions useful or reducing problems related to fire. The compositions may be used for molded articles or as coatings.

U.S. Pat. No. 5,245,809 discloses flame retardant urethane foam panels useful for walls, roofs and floors. The panel includes at least two essentially parallel face members separated to form a space between the face members and urethane within the space to provide thermal insulation and flame retardant properties.

U.S. Pat. No. 5,606,841 discloses interior wall panels having a rigid frame backing member to which an outer pliable sheet material is secured. A filling or padding is retained between the sheet material and the backing member and the sheet material is secured through the filling in a plurality of spaced locations to thereby create a three-dimensional surface relief. The filling may be foam, fiber or rubber.

### SUMMARY OF THE INVENTION

The present invention relates to an article of manufacture. It is suitable for use in the construction industry. For example, the article could be used as a ceiling or wall material. The article is particularly suitable as wallboard or as a partitioning/divider board. However, the article of the present invention can also be used in any application or industry where a lightweight and durable material is needed.

The article comprises a bonded nonwoven structure sandwiched between two layers of paper, wherein the bonded nonwoven structure comprises a binder and a load-bearing fiber. The load-bearing fiber has a shape factor between about 2 and 6, a short range distortion factor (SRDF) between about 5 and 70, a long range distortion factor (LRDF) between about 0.1 and 0.6, and a denier per filament (dpf) between about 3 and 200.

It is also an object of the present invention to provide a method for making the article. One such preferred method comprises:

obtaining a load-bearing fiber and a binder,

blending the load-bearing fiber and the binder to form a blended structure,

compressing the blended structure to a desired density,

heating the blended structure to effect bonding and to form a bonded structure,

laminating the bonded structure between two sheets of paper, and

securing the paper to the bonded structure.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DETAILED DESCRIPTION OF THE DRAWINGS

The present invention will become more fully understood from the detailed description and the accompanying drawings, wherein:

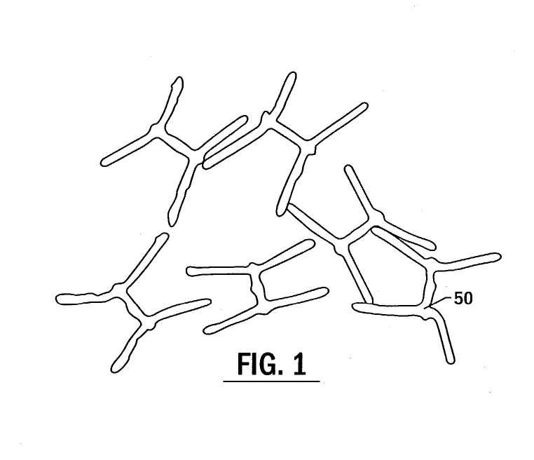

FIG. 1 illustrates the cross-section of a 4TA-9 fiber 50 as set forth in Example 1.

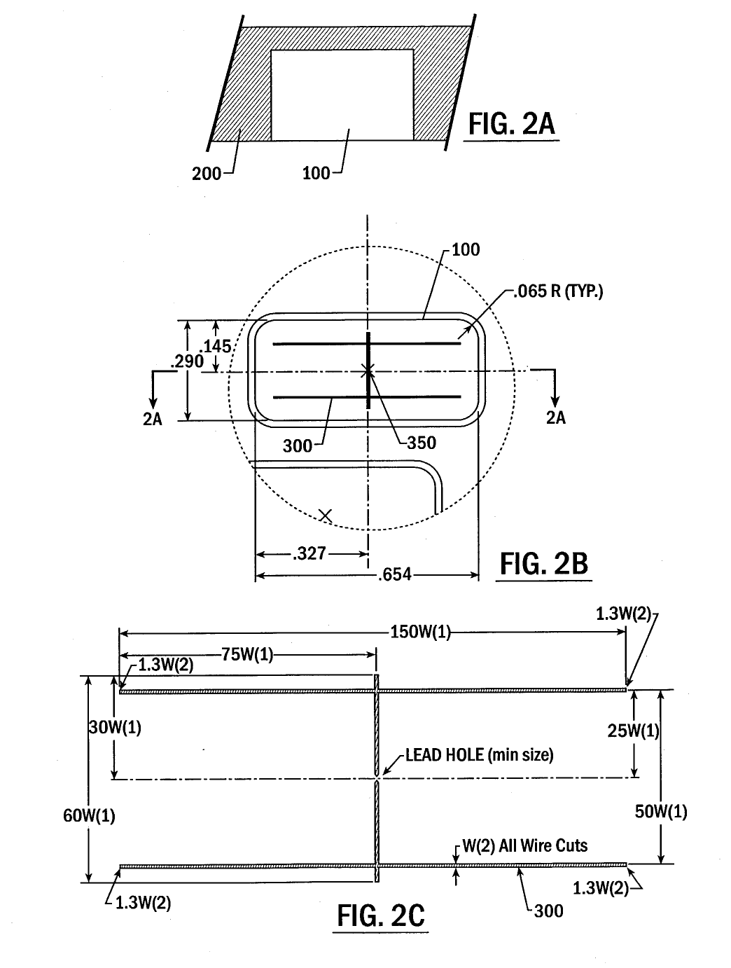

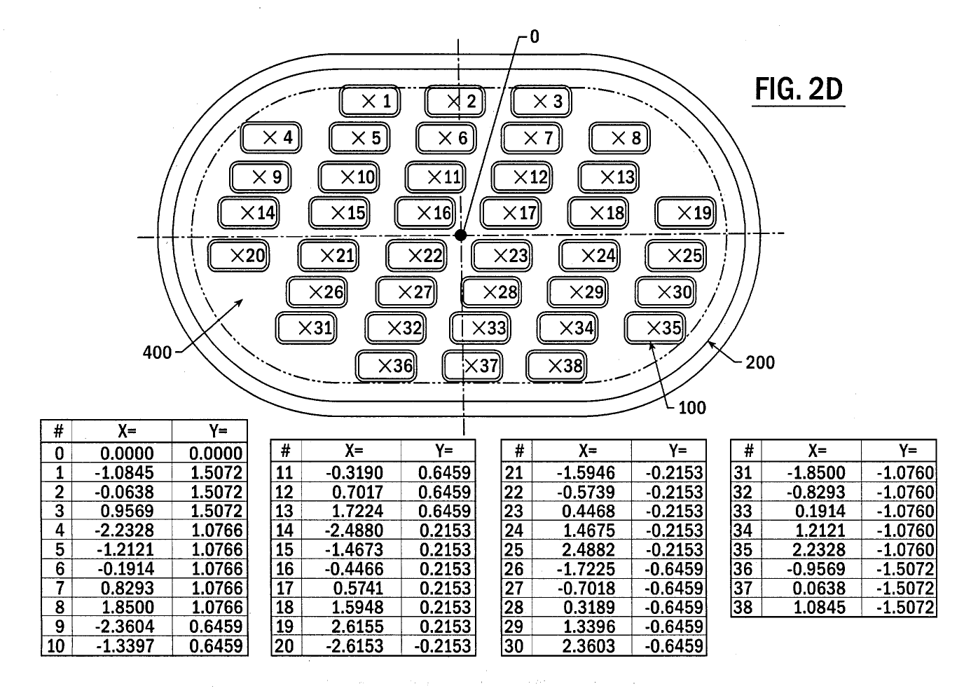

FIG. 2A is a partial sectional view showing the bore 100 for an aperture of the spinneret 200 that may be used in Example 1.

FIG. 2B is an enlarged view of a representative aperture 300 having a locating point 350 in the bore 100 of spinneret 200 of FIG. 2D. R is the radius.

FIG. 2C is a schematic showing the aperture shape and dimensions of aperture 300 of spinneret 200 that may be used in Example 1. W is the width. W(1) is 0.100 mm WIRE CUT and W(2) is 0.084 mm WIRE CUT.

FIG. 2D is an example of spinneret 200 that may be used in Example 1 having the bores 100 and apertures (not shown) having respective locating points 1 to 38 in the aperture pattern 400.

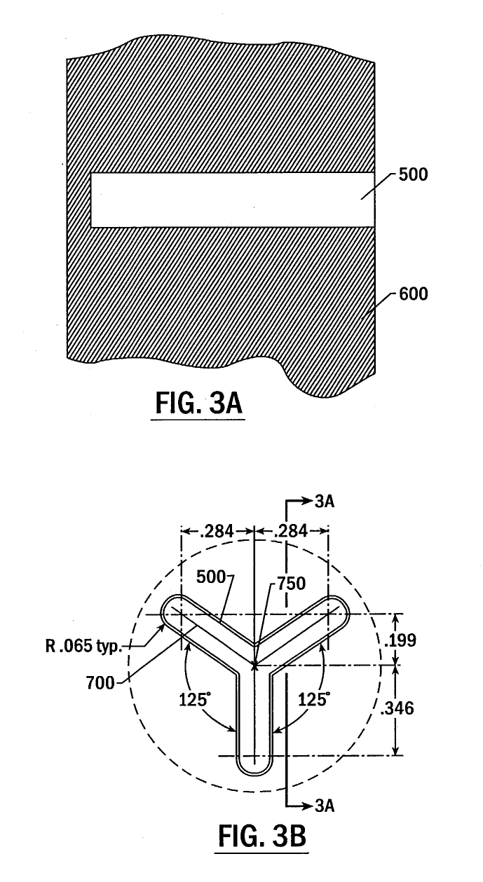

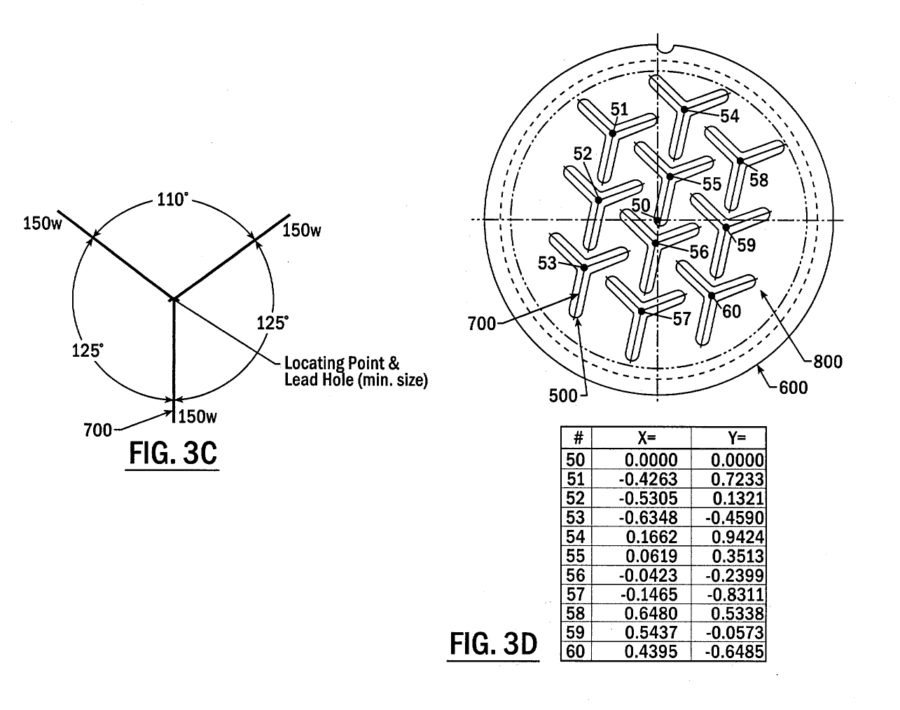

FIG. 3A is a partial sectional view showing the bore 500 for an aperture of the spinneret 600 that may be used in Example 2.

FIG. 3B is an enlarged view of a representative aperture 700 having a locating point 750 in the bore 500 of spinneret 600 of FIG. 3D. R is the radius.

FIG. 3C is a schematic showing the aperture shape and dimensions of aperture 700 of spinneret 600 that may be used in Example 2. W is the width and W is 0.067 mm.

FIG. 3D is an example of spinneret 600 that may be used in Example 2 having the bores 500 and apertures 700 having respective locating points 51 to 60 in the aperture pattern 800.

### DESCRIPTION OF THE PREFERRED EMBODIMENTS

The following description of the preferred embodiment(s) is merely exemplary in nature and is in no way intended to limit the invention, its application, or uses.

The present invention relates to an article of manufacture comprised of a bonded nonwoven structure sandwiched between two layers of paper.

The bonded nonwoven structure comprises a load-bearing fiber and a binder. The load-bearing fiber is a component that retains its integrity during the manufacture of the structure and provides the actual strength (compression/tensile/torsion) during use. A suitable fiber for use as the load-bearing fiber in the present invention is disclosed in U.S. Pat. No. 5,977,429, herein incorporated by reference. The load-bearing fiber is preferably a short, highly distorted, and bulky material. The load-bearing fiber preferably has a shape factor between about 2 and 6, a short range distortion factor (SRDF) between about 5 and 70, a long range distortion factor (LRDF) between about 0.1 and 0.6, and a denier per filament (dpf) between about 3 and 200.

The binder may be a binder fiber or a binder powder. An example of a suitable binder powder includes, but is not limited to, EMS 6P82 commercially available from Ems-Chemie North America of Sumter, S.C. Examples of suitable binder fiber include, but are not limited to, bicomponent fiber T4050 commercially available from Sam Yang Company of South Korea; unicomponent Eastman polyester binder fibers, Types 410 and 438 formerly from Eastman Chemical Company; Cellbond products commercially available from KoSa; and Melty products commercially available from Unitika of Japan. Binder fibers are fibers that are used to bond nonwoven structures together using heat, or heat and pressure. The binder fiber may be a single component or a bicomponent fiber. Typically, the binder fiber or the low melting sheath of the binder fiber has a lower melting/flow point than the load-bearing fiber and when the structure is heated the binder fiber flows and bonds the structure together.

The density of the nonwoven structure ranges between about 1 lb/ft³ (16 kg/m³) and 15 lb/ft³ (240 kg/m³). The percentage of binder by weight varies from about 5% to 40% based upon the weight of the nonwoven structure.

Typically, the amount of binder present in the bonded nonwoven structure is less than the amount of load-bearing fiber present in the structure. Preferred ratios of load-bearing fiber to binder include about, but are not limited to, 80:20, 75:25, and 65:35. If increased rigidity of the structure is desirable, the higher level of bonding material may be used.

The load-bearing fiber is “short” means that each fiber has a length along its axis of between about 2 and about 37 millimeters, preferably between about 2 and 19 millimeters.

The load-bearing fiber is “bulky” means that each fiber has a single fiber bulk factor (SFBF) of between 0.5 and 10.0, preferably between 1.5 and 7.5. SFBF is a measure of the ratio of void areas to solid polymer area of the cross-section of the fiber. Since the load-bearing fibers have varying cross-sections along their length, the SFBF is an average of 50 cross-section measurements.

Bulkiness is also a characteristic of the as spun fiber. “As spun” means the state of the load-bearing fibers prior to the step of shrinking or drawing. The as spun fibers have non-round cross-section shapes and include those fibers disclosed in U.S. Pat. Nos. 5,200,248; 5,268,229, 5,611,981 and 6,103,376. In combining the teachings of the above references, the as spun fibers may be characterized by the following two classifications:

1. The fibers are those classified as having “good” capillary channels on their surface such that the fibers have (a) a Specific Capillary Volume of at least 2.0 cc/g and a Specific Capillary Surface Area of at least 2000 cm²/g, or (b) a Slenderness Ratio of at least 9 and at least 30 percent of intra-fiber channels with a capillary channel width of less than 300 microns.

2. The fibers are those classified as having “poor” or no capillary channels on their surface such that the fibers have (a) a Specific Capillary Volume of less than 2.0 cc/g or a Specific Capillary Surface Area of less than 2000 cm²/g, and (b) a Slenderness Ratio of less than 9 or more than 70% of intra-fiber channels with a capillary channel width of greater than 300 microns. Preferably, these as spun fibers have a SFBF of greater than 4.0.

Details of measuring the parameters set forth above for the as spun fibers are discussed below.

The load-bearing fibers are highly distorted having highly variable cross-section shapes caused by a sinuous or ruffled character of arms of the fiber or walls of channels of the fiber relative to the backbone or spine of the fiber from which the arms or the walls project. That is, the arms or walls of the cross-section of the fibers are highly distorted. The distorted shape in this context is created from the shape of an as spun fiber that has undergone the step of shrinking. During shrinking, the cross-section shape of the as spun fiber distorts. Channels refer to the ruffled walls coupled with a base defining one or more channels.

Distortions of the load-bearing fiber of the present invention are characterized by a short range distortion factor (SRDF), a measure of the channel area variability along the fiber, and a long-range distortion factor (LRDF) for the length, i.e backbone, of the fiber. The SRDF is greater than 5.0, preferably between 5 and 70, and more preferably between 18 and 36. The LRDF is between 0.05 and 0.9, preferably between are 0.1 and 0.6.

The SRDF is defined as the percent of the coefficient variation of the ratio of the area of channels Cₐᵣₑₐ to the area of the cross-section of the fiber material Mₐᵣₑₐ for fifty measurements on randomly selected cross-sections of the fibers. Thus,

SRDF=100*(σ/X)

wherein X equals the average (Cₐᵣₑₐ/Mₐᵣₑₐ) for measurements on fifty cross-sections and σ equals the standard deviation of the 50 values for (Cₐᵣₑₐ/Mₐᵣₑₐ).

For any cross-section, the channel area Cₐᵣₑₐ is determined by first enclosing the cross-section in a polygon whose segments are tangent to two points on the cross-section and intersect at angles interior to the polygon of less than 180 degrees. Each channel area is defined by the surfaces of the cross-section of the fiber and the line segments tangent to the two points on the cross-section. All channel areas are included in the value for Cₐᵣₑₐ for cross-section of a fiber. Thus, the value of Cₐᵣₑₐ is equal to the sum of the area of channels. The fiber material area Mₐᵣₑₐ is the area of the cross-section of the fiber. For each cross section, the ratio of Cₐᵣₑₐ to Mₐᵣₑₐ is determined. The average and the standard deviation of the ratio of the Cₐᵣₑₐ to Mₐᵣₑₐ is determined for fifty cross sections. Once the average and the standard deviation have been measured, the SRDF is calculated.

LRDF is a function of L₁ and L₀. L₀ is the average length along the backbone or spine of the load-bearing fiber. L₁ is the diameter of the circle circumscribing the load-bearing fiber. L₀ and L₁ are measured using photomicrographs. The fibers are placed on a microscope slide and a photomicrograph at a known magnification, such as a magnification of about 7, is taken. The lengths L₁ and L₀, while measured from the photomicrograph, are the actual lengths of the backbone and diameter, respectively. These lengths may be approximated using a ruler. Alternatively, a computer imaging and measurement system may be used to determine L₀, L₁, and LRDF.

In one embodiment, the computer based imaging and measurement system to determine LRDF includes an optical system for obtaining images of the fiber, which is programmed with algorithms for measuring lengths of the fiber, and a printer for making copies of the fiber images. The optical system includes an illuminated base, a video camera equipped with a macro lens, and a conventional personal computer that includes an image grabber board. The width of the field of view for each image is preferably at least 15 millimeters at the desired magnification allowing for the entire length of the load-bearing fibers to be in the field of view. Verification of the magnification in the image is done using a ruler in the field of view and an algorithm that sets the scale in the image field based upon the distance between points identified in the field of view.

Various algorithms can be used in the measuring system to determine L₀ and L₁. The determination of L₀ may be accomplished by tracing the insertion point along the length of the image of the fiber using an input/output mouse type of device. Alternatively, the ends of the image of the fiber can be identified using a mouse type device and the computer can be instructed to run an algorithm to determine the length of the fiber based upon the identification of the two end points and fiber image in the image field. L₁ can also be determined with the aid of the measuring system. The distal points of the fiber can be identified and the length between those points equated with the diameter of the circumscribing circle. Alternatively, the points in the image field corresponding to the fiber can be identified by the computer, and the computer can run an algorithm to fit a circle around the fiber that circumscribes the fiber.

To provide bulkiness and distortion, the shape of the cross-section of the load-bearing fibers may be distorted “H”, “Y”, “+”, or “U” shapes. The load-bearing fiber cross-section shape is a distorted shape of the as spun fiber. Of course, the as spun fiber cross-section shapes may be the non-distorted shapes “H”, “Y”, “+”, “U”, or what is referred to in the industry as “4DG,” or modifications and variations thereof. Other non-round cross-sections with high shape factors (>2) will work also.

The load-bearing fibers have a denier of between 3 and 100 dpf and more preferably between 3 and 30 dpf. Denier per filament (dpf) is the average denier of the individual fiber measured in grams of fiber per 9000 meters of the individual fiber.

Preferably, the load-bearing fibers of the invention are made from a polyester such as poly(ethylene terephthalate) or poly(butylene terephthalate). However, the load-bearing fibers may also be formed from other polymers that shrink significantly when heated such as polystyrene or foamed polystyrene. The step of shrinking introduces the distortion in the fiber that increases the LRDF and SRDF. Shrinking occurs for oriented amorphous polymeric fibers when the fibers are heated above their glass transition temperature. The shrinking occurs either prior to or in the absence of substantial crystallization.

The load-bearing fibers of the invention may be treated with surface finishes. Surface finishes are well known in the art and are commercially available. Any number of surface finishes are suitable for use in the present invention including, but not limited to, the finish of Example 1.

The surface finishes are typically coated on fibers during their manufacture. The coating, i.e. lubricating step, usually occurs just after the molten polymer is extruded through the aperture of a spinneret and quenched, but it can be applied later as discussed below. The thickness of the coating is much thinner than the cross-section of the fiber and is measured in terms of its percent of the total weight of the fiber. The weight percent of the coating is typically between 0.005 and 2.0 percent of the total weight of the fiber. Higher levels may be required for a non-round fiber since the surface area of the fiber to be coated is greater.

The load-bearing fibers of the present invention can be made by several different processes. However, the following four sequences of steps are preferable for making the load-bearing fibers.

Process sequence of steps:

1. Spin, cut, shrink, lube

2. Spin, shrink, lube, cut

3. Spin, draw, cut, shrink, lube

4. Spin, draw, shrink, lube, cut

The spin step means conventionally extruding molten polymer through apertures in a spinneret forming shaped fibers. When the molten polymer is poly(ethylene terephthalate) the extrusion is at a temperature of about 270 to 300° C. The viscosity of the molten polymer exiting the aperture is preferably between 400 to 1000 poise. The spin step also includes cooling the extruded polymer to form a fiber having an as spun shape, lubricating the fiber, and then transporting the fiber. The preferred transporting (spinning) speeds are between 500 and 3500 meters per minute (m/min). Higher spinning speeds may result in the onset of crystallization in the extruding fiber. Crystallization reduces the ability of the fiber to shrink in the subsequent shrink step and thereby inhibits the formation of the structural distortions. Preferably, the spinning speeds are from 1000 to 1500 m/min and 2500 to 3200 m/min depending on the polymeric material used. Obviously cross-section preservation and amorphous orientation differences within a cross-section are important during the spinning of these fibers. Typically, relatively low melt temperatures, relatively high molecular weight polymers, relatively high quench rates and possible melt surface tension reduction are used to produce the desired shapes and the amorphous orientation differences.

The cut step means conventionally cutting the fibers. The cut lengths of the load-bearing fibers of the present invention are short as compared to the conventional cut lengths of staple PET fibers, typically one and one half inches. The lengths of the cut load-bearing fibers are from 2 to 37 millimeters (mm).

The final lengths of the load-bearing fibers are not necessarily the lengths of the fibers during intermediate steps in the manufacturing process. For example, in the shrink-cut processes (i.e., in the process involving sequential steps of first shrinking the fibers and then cutting the fibers), the fibers are cut to the desired lengths of between 2 and 37 mm. However, in the cut-shrink processes (i.e., in the process involving sequential steps of first cutting the fibers and then shrinking the fibers), the fibers are cut to a longer length than the desired length and then shrunk to the desired length.

The shrink step occurs by subjecting the as spun fiber or a drawn fiber to an environment having a sufficient temperature to effect shrinking of the fiber to a denier of at least 5 percent, preferably 25 percent, greater than the denier prior to shrinking. The shrinking may be done as a modification of a conventional fiber staple process. The shrink step differs depending on whether the process is either shrink-cut or cut-shrink.

In the shrink-cut process, the load-bearing fibers are preferably formed into a tow. The fibers in the tow are then shrunk. The tow is delivered to the shrinking environment at a first speed and removed from the environment at a second speed, which is slower than the first speed. For example, a heated water bath at a temperature of between 70 and 100° C. may be used to shrink the fiber. The fiber is constrained at both ends of the bath by rolls or drums so that the fiber cannot freely rotate. This shrink process is called rotationally constrained shrink. Shrinking the tow in steam or in a hot oven is also possible. The take-up roll that pulls the fiber out of the shrinking region has a lower surface speed than the feed roll delivering the fiber to the heated shrinking region. This difference in delivery and take-up speeds allows the fiber to shrink in the heated shrinking region.

In the cut-shrink process, the cutting of the load-bearing fibers is performed before the shrinking of the fibers. In this process, which is typically called three-dimensional free shrink, the fibers are not constrained during the shrink process. The shrinking may be performed by immersing the cut fibers in an environment suitable to effect shrinking, such as water, hot air, or steam. The cut-shrink process is particularly suitable for high-speed operations on the order of between 2000 and 3500 meters per minute. The spinning, cutting, and shrinking are consecutively and continuously done. For example, a cut shrink process could be designed to provide spinning speeds of about 3000 meters per minute with correspondingly high rates of cutting and with the shrinking done in a high velocity turbulent hot air chamber with a residence time of 1 to about 30 seconds. The shrunk fiber then passes out of the turbulent hot air chamber.

In an alternative cut-shrink process, the shrinking step does not occur immediately following the cutting step. For example, the product from the continuous spinning-cutting process can be used to feed a paper-making machine. The step of shrinking can take place at the location of the paper-making machine.

The lube step means applying a surface finish to the shrunk fiber. Often the surface finish applied in the spinning step is removed during the shrinking step and another application is necessary. Any conventional finish application process may be used. Examples include applying the surface finish using spray booths, lube rolls, metered tips, or even a hot water/lube bath as used for shrinking the fibers.

The drawing step is optional and may be either a conventional tow or filament drawing step of the type used to form staple fibers, but which does not use heat setting. The main purposes of the drawing step are to reduce the denier per filament of the product, to increase the amorphous orientation differences within a given filament cross-section, and to increase the amorphous orientation of the polymer chains along the fiber axis. Thus, by drawing the fiber before shrinking, the shrinking step will tend to maximize SRDF and/or LRDF. The drawing is performed under substantially amorphous retaining conditions so that the necessary distortions occur when the drawn structure is shrunk. Because of the rotational constrained free shrink, the shrink-cut processes tend to give relatively high values of SRDF and relatively low values of LRDF compared to the cut-shrink processes.

The present invention also relates to a method of making the article of the present invention, preferably the wallboard. As discussed above, a load-bearing fiber and a binder are obtained. The load-bearing fiber and the binder are blended to form a blended structure. The components may be blended using conventional means or by any means known to one of ordinary skill in the art. For example, the components may be blended using cyclone type blenders. Preferably, the components are blended to a lower density than the desired density such that the desired density can be controlled. The blended structure is then compressed to the desired density. Compression may occur by conventional means or by any means known to one of ordinary skill in the art; however, compression preferably occurs between heated rollers. Whether or not one has reached the desired density can be determined by measuring the density of the final product. The heated rollers, for example, may be widened or narrowed to obtain the desired density. The blended structure is then heated to affect bonding and to form a bonded structure. Heating may occur by conventional means or by any means known to one of ordinary skill in the art. Preferably, heating using heated rollers is desirable. Heating typically occurs for about 1 to 30 seconds at a temperature of about 120 to 200° C. The bonded structure is laminated between two sheets of paper. The nonwoven structure must adhere to the paper. Paper may be used with an adhesive on one or more of its sides. It is preferred that the paper is placed between the nonwoven structure and the heated rolls such that the paper adheres when the bonding of the structure takes place. Calendering equipment is appropriate for this purpose. The paper is secured to the bonded structure, for example, by adhesive as discussed above.

In the method of the present invention, laminating may occur before compressing and heating, or compressing and laminating may occur in the same step. The binder may be used to bind the nonwoven to the paper in this variation. Laminates of these materials with other materials such as plywood or gypsum wallboard are within the scope of this invention.

An advantage of the article of the present invention is its low cost and ease of installation. It can also be made as flame retardant as necessary, for example, by incorporating additives such as flame retardants. The ability to suppress sound is also an important feature of the present invention.

The articles of the present invention are particularly suitable as wallboards for covering walls and ceilings. The papers chosen for the lamination may be paintable. Examples of suitable commercially available papers include, but are not limited to, any kind of cellulosic or cellulose blend paper, thin or thick, paintable, textured or printable paper. The term “paper” as used in the context of the present invention also includes thin plastic films. Thinner versions of the articles at lower densities may be used where currently foam boards are used.

Surprisingly, the load-bearing fibers which were designed for a different purpose, namely for use in absorbent articles, can be used to make the articles of the present invention. The stiff brittle nature of these fibers allows them to be processed without the need for expensive carding equipment. The use of fibers much larger than normal textile fibers, enables the required stiffness and hardness for applications like wallboard.

Although the density of the final structure may vary widely depending upon the end use, typically the density ranges from about 1 lb/ft³ to about 20 lb/ft³. For example, if a board with a higher impact resistance is needed, a structure with a higher density will be required. The thickness of the boards may vary from about ⅛ inch (0.0318 cm) up to 4 inches (10.16 cm). Typically, the nominal thickness is between about ¼ inch (0.635 cm) and 2 inches (5.08 cm). The paper required on the outside of the structure will depend upon the application. Standard wallboard is typically about 4 ft (121.9 cm) by 8 ft (243.8 cm). Variations are within the scope of the present invention.

### EXAMPLES

### Example 1

A wallboard was prepared. The load-bearing fiber used to make the wallboard was a 75/25 blend of ¼ inch (6.35 mm) 4TA-9 fiber and ¼ inch (6.35 mm) sheath core bicomponent fiber designated T4050 having a dpf of 4.0 made by commercial supplier Sam Yang.

The 4TA-9 fiber precursor was an as spun polyethylene terephthalate fiber having an as spun dpf of 23.8 and a cross-section as shown in FIG. 1.

The as spun fiber was then processed by drawing the fiber (1.3×), shrinking the fiber, lubricating the fiber and cutting the fiber (i.e. the “shrink-cut” process). The fiber had a nominal length of approximately ¼ inch (6.35 mm). The final dpf of the resultant fiber was 50.9. The resultant fiber had the following characteristics: an actual length of 7.5 mm, a shape factor of 4.1, a SRDF of 28, and a LRDF of 0.13.

In the spinning step, an oval spinneret I1083 as shown in FIGS. 2A-2D was used. The 4TA-9 comprised 0.82% spinning lubricant, wherein the percent by weight was based on the weight of the fiber plus the lubricant. The lubricant used was a 10 weight percent solids water dispersion of the following components: 10 weight percent solution of poly[polyethylene glycol (1400) terephthalate], 44.1 weight percent solids polyethylene glycol (400) monolaurate (oxyethylene fatty acid ester), 44.1 weight percent solids polyethylene glycol (600) monolaurate (oxyethylene fatty acid ester) and 1.8 weight percent solids 4-cetyl, 4-ethyl morpholinium ethosulfate (alkyl quaternary ammonium salt of inorganic ester).

An intimate blend of the above fibers at the 75/25 level was prepared and placed between two sheets of label paper adhesive on one side, the adhesive side next to the fibers. The sample was compressed to a density of 6.7 lb/ft³ with a corresponding thickness of 1 cm and heated to a temperature of 150 degrees Celsius for a period of 1 minute to enable the bonding. The resulting wallboard was light, sturdy and was to provide excellent thermal and sound insulating characteristics.

### Example 2

Example 1 was repeated except that the load-bearing fiber used was fiber cut 1 inch (25.4 mm) before shrinking. The resultant 110 dpf fiber was spun from a “Y” shaped hole spinneret I1195 as shown in FIGS. 3A-3D. Other important characteristics of the resultant fiber were a shape factor of 5.1, a SRDF of 23, and an LRDF of 0.51. The 75/25 blend was intimately blended and compressed between two sheets of label paper to a density of about 3.2 lb/ft³ (51.2 kg/m³) and heated for one minute at a temperature of 150 degrees Celsius. The resultant wallboard was lighter but firmer than the board of Example 1.

It will therefore be readily understood by those persons skilled in the art that the present invention is susceptible to broad utility and application. Many embodiments and adaptations of the present invention other than those herein described, as well as many variations, modifications and equivalent arrangements, will be apparent from or reasonably suggested by the present invention and the foregoing description thereof, without departing from the substance or scope of the present invention. Accordingly, while the present invention has been described herein in detail in relation to its preferred embodiment, it is to be understood that this disclosure is only illustrative and exemplary of the present invention and is made merely for purposes of providing a full and enabling disclosure of the invention. The foregoing disclosure is not intended or to be construed to limit the present invention or otherwise to exclude any such other embodiments, adaptations, variations, modifications and equivalent arrangements.

We claim:

1. An article of manufacture comprising a bonded nonwoven structure sandwiched between two layers of paper, wherein the bonded nonwoven structure comprises a binder and a load-bearing fiber wherein the load-bearing fiber has a shape factor between about 2 and 6, a short range distortion factor (SRDF) between about 5 and 70, a long range distortion factor (LRDF) between about 0.1 and 0.6, and a denier per filament (dpf) between about 3 and 200.

2. The article of manufacture as claimed in claim 1, wherein the binder is present in the bonded nonwoven structure in an amount less than the amount of the load-bearing fiber in the bonded nonwoven structure.

3. The article of manufacture as claimed in claim 1, wherein the load-bearing fiber is in a ratio to the binder of about 80:20.

4. The article of manufacture as claimed in claim 1, wherein the load-bearing fiber is in a ratio to the binder of about 75:25.

5. The article of manufacture as claimed in claim 1, wherein the load-bearing fiber is in a ratio to the binder of about 65:35.

6. A wallboard comprising a bonded nonwoven structure sandwiched between two layers of paper, wherein the bonded nonwoven structure comprises a binder and a load-bearing fiber wherein the load-bearing fiber has a shape factor between about 2 and 6, a short range distortion factor (SRDF) between about 5 and 70, a long range distortion factor (LRDF) between about 0.1 and 0.6, and a denier per filament (dpf) between about 3 and 200.

7. The wallboard as claimed in claim 6, wherein the binder is present in the bonded nonwoven structure in an amount less than the amount of the load-bearing fiber in the bonded nonwoven structure.

8. The wallboard as claimed in claim 6, wherein the load-bearing fiber is in a ratio to the binder of about 80:20.

9. The wallboard as claimed in claim 6, wherein the load-bearing fiber is in a ratio to the binder of about 75:25.

10. The wallboard as claimed in claim 6, wherein the load-bearing fiber is in a ratio to the binder of about 65:35.

11. A method of making an article of manufacture, the method comprising:
obtaining a load-bearing fiber and a binder,
blending the load-bearing fiber and the binder to form a blended structure,
compressing the blended structure to a desired density,
heating the blended structure to effect bonding and to form a bonded structure,
laminating the bonded structure between two sheets of paper, and
securing the paper to the bonded structure.

12. The method as claimed in claim 11, wherein the binder is present in an amount less than the amount of the load-bearing fiber.

13. The method as claimed in claim 11, wherein the load-bearing fiber is in a ratio to the binder of about 80:20.

14. The method as claimed in claim 11, wherein the load-bearing fiber is in a ratio to the binder of about 75:25.

15. The method as claimed in claim 11, wherein the load-bearing fiber is in a ratio to the binder of about 65:35.

16. The method as claimed in claim 11, wherein the load-bearing fiber has a shape factor between about 2 and 6, a short range distortion factor (SRDF) between about 5 and 70, a long range distortion factor (LRDF) between about 0.1 and 0.6, and a denier per filament (dpf) between about 3 and 200.

17. A method of making a wallboard, the method comprising:
obtaining a load-bearing fiber and a binder,
blending the load-bearing fiber and the binder to form a blended structure,
compressing the blended structure to a desired density,
heating the blended structure to effect bonding and to form a bonded structure,
laminating the bonded structure between two sheets of paper, and
securing the paper to the bonded structure.

18. The method as claimed in claim 17, wherein the load-bearing fiber has a shape factor between about 2 and 6, a short range distortion factor (SRDF) between about 5 and 70, a long range distortion factor (LRDF) between about 0.1 and 0.6, and a denier per filament (dpf) between about 3 and 200.

19. The method as claimed in claim 17, wherein the binder is present in an amount less than the amount of the load-bearing fiber.

20. The method as claimed in claim 17, wherein the load-bearing fiber is in a ratio to the binder of about 80:20.

21. The method as claimed in claim 17, wherein the load-bearing fiber is in a ratio to the binder of about 75:25.

22. The method as claimed in claim 17, wherein the load-bearing fiber is in a ratio to the binder of about 65:35.

23. A method of making a wallboard, the method comprising:
obtaining a load-bearing fiber and a binder,
blending the load-bearing fiber and the binder to form a blended structure,
laminating the blended structure between two sheets of paper,
compressing the blended structure to a desired density,
heating the blended structure to effect bonding and to form a bonded structure, and
securing the paper to the bonded structure.

24. The method as claimed in claim 23, wherein the load-bearing fiber has a shape factor between about 2 and 6, a short range distortion factor (SRDF) between about 5 and 70, a long range distortion factor (LRDF) between about 0.1 and 0.6, and a denier per filament (dpf) between about 3 and 200.

25. The method as claimed in claim 23, wherein the binder is present in an amount less than the amount of the load-bearing fiber.

26. The method as claimed in claim 23, wherein the load-bearing fiber is in a ratio to the binder of about 80:20.

27. The method as claimed in claim 23, wherein the load-bearing fiber is in a ratio to the binder of about 75:25.

28. The method as claimed in claim 23, wherein the load-bearing fiber is in a ratio to the binder of about 65:35.

29. A method of making a wallboard, the method comprising:
obtaining a load-bearing fiber and a binder,
blending the load-bearing fiber and the binder to form a blended structure,
laminating the blended structure between two sheets of paper and compressing the blended structure to a desired density,
heating the blended structure to effect bonding and to form a bonded structure, and
securing the paper to the bonded structure.

30. The method as claimed in claim 29, wherein the load-bearing fiber has a shape factor between about 2 and 6, a short range distortion factor (SRDF) between about 5 and 70, a long range distortion factor (LRDF) between about 0.1 and 0.6, and a denier per filament (dpf) between about 3 and 200.

31. The method as claimed in claim 29, wherein the binder is present in an amount less than the amount of the load-bearing fiber.

32. The method as claimed in claim 29, wherein the load-bearing fiber is in a ratio to the binder of about 80:20.

33. The method as claimed in claim 29, wherein the load-bearing fiber is in a ratio to the binder of about 75:25.

34. The method as claimed in claim 29, wherein the load-bearing fiber is in a ratio to the binder of about 65:35.

35. The article of manufacture as claimed in claim 1, wherein the article of manufacture has a density from about 1 lb/ft³ to about 20 lb/ft³.

36. The wallboard as claimed in claim 6, wherein the wallboard has a density from about 1 lb/ft³ to about 20 lb/ft³.

37. The method as claimed in claim 11, wherein the article of manufacture has a density from about 1 lb/ft³ to about 20 lb/ft³.

38. The method as claimed in claim 17, wherein the wallboard has a density from about 1 lb/ft³ to about 20 lb/ft³.

39. The method of making as claimed in claim 23, wherein the wallboard has a density from about 1 lb/ft³ to about 20 lb/ft³.

40. The method of making as claimed in claim 29, wherein the wallboard has a density from about 1 lb/ft³ to about 20 lb/ft³.
